(19) United States
(12) Patent Application Publication
(10) Pub. No.: US 2007/0209212 A1
(43) Pub. Date: Sep. 13, 2007

(54) Card brace forming apparatus

(76) Inventors: T. Kevin Vick, Thomasville, GA (US); Douglas M. Vick, Boston, GA (US)

Correspondence Address: JONES DAY, 77 WEST WACKER, CHICAGO, IL, 60601-1692, US

(21) Appl. No.: 11/369,801

(22) Filed: Mar. 7, 2006

(51) Int. Cl. B26B 13/00

(52) U.S. Cl. 30/229

(57) ABSTRACT

An apparatus for perforating or cutting and scoring paper cards, such as greeting and place cards. The apparatus includes hinged first and second arms held open by a spring. A die and a platen are attached to the arms and include a long blade, two spaced apart short blades, a scoring bar and spacer bars. An edge of a card is placed between the die and the platen against the spacer bars and when the arms are brought together, the card is cut and scored so that a brace is formed from one of the card panels. The brace is separable and may extend from one panel to another to provide support for the card when the card is displayed. The apparatus may be hand held and hand operated or the die and platen may be attached to powered stamping equipment.

### CROSS REFERENCE TO RELATED APPLICATIONS

Not applicable.

### STATEMENT REGARDING FEDERALLY SPONSORED RESEARCH

Not applicable.

### BACKGROUND OF THE INVENTION

1. Field of the Invention

The present invention relates to a brace forming apparatus and more particularly to a card brace forming apparatus, which may be machine operated or hand held and hand operated, for perforating or cutting a portion of, for example, a paper card such as a greeting or place card to form a brace and enable the stable display of the card.

2. Description of the Related Art

As explained in co-pending application entitled “Support System For A Paper Card And Method Of Forming Same”, application Ser. No. ______ (Attorney Docket No. 694895-600001), filed on even date with the present application, and incorporated herein by reference in its entirety, cards in the form of greeting cards are often displayed in a partially opened or “A-frame” position on a mantle or shelf, especially at holiday time. Other paper cards, such as place cards, frequently used at weddings and parties, are intended to be placed on tables in a partially opened position to indicate seating arrangements. Usually, such cards are supposed to be self-supporting, that is, the cards support themselves, but they tend not to be very stable. Many people have experienced the problem of walking past such cards, creating a slight disturbance of the surrounding air, and watching the cards fall over. At other times, the cards may sag under their own weight.

A solution to the poor card stability problem is described in the above mentioned application Ser. No. ______. As explained, a brace is provided that extends from one of the card panels to the other panel thereby acting as a brace to support the card in a partially opened condition. This brace may be formed from part of the card or the brace may be provided as a separate item.

### BRIEF SUMMARY OF THE INVENTION

What is described here is an apparatus for forming a brace from the paper card, the apparatus including a die having an elongated cutting blade and first and second shorter cutting blades disposed at generally right angles to the elongated blade where the first and second shorter cutting blades are generally parallel to each other. The apparatus may also include a platen and a scoring bar, and spacer bars may be formed on either the die or the platen to facilitate operation of the apparatus.

The apparatus may be hand held and hand operated so that a card recipient, for example, may form a brace using the apparatus from the card that is received.

There are a number of advantages to the apparatus including its simple, elegant design, it s ease of use and its relatively inexpensive construction.

A complete understanding of the present invention and other advantages, objects and features thereof will be gained from a consideration of the present specification which provides a written description of the invention and of the manner and process of making and using the invention set forth in such full, clear, concise and exact terms as to enable any person skilled in the art to which it pertains, or with which it is most nearly connected, to make and use the same in compliance with Title 35 U.S.C. §112 (first paragraph). Furthermore, the following description of preferred embodiments of the invention read in conjunction with the accompanying drawing provided herein represents examples of the invention in compliance with Title 35 U.S.C. §112 (first paragraph), but the invention itself is defined in the Claims section attached hereto.

### BRIEF DESCRIPTION OF THE SEVERAL VIEWS OF THE DRAWING

FIG. 1 is an isometric view of a paper card showing an embodiment of a brace formed from the card.

FIG. 2 is a partial isometric view of the paper card shown in FIG. 1 on a display surface illustrating the brace partially separated and in an operative position.

FIG. 3 is an isometric view of an embodiment of the apparatus of the present invention illustrated in an open position.

FIG. 4 is an isometric view of the apparatus shown in FIG. 3 and illustrated in a closed or brace forming position with a partial view of a paper card.

FIG. 5 is a sectional elevation view of the apparatus shown in FIG. 3.

FIG. 6 is a plan view of the apparatus' die taken along line 6-6 of FIG. 5.

FIG. 7 is a plan view of the apparatus' platen taken along line 7-7 of FIG. 5.

FIG. 8 is an isometric view of an elongated blade having a continuous cutting edge.

FIG. 9 is an isometric view of a cutting blade having an interrupted cutting edge.

FIG. 10 is an isometric view of a cutting blade having a saw tooth cutting edge.

FIG. 11 is an isometric view of a scoring bar.

FIG. 12 is an isometric view of a spacing bar.

FIG. 13 is an isometric view of another embodiment of a paper card showing a brace attached to the card.

FIG. 14 is an isometric view of the paper card of FIG. 13 with the brace separated from the card.

FIG. 15 is an isometric view of the paper card and the brace shown in FIGS. 13 and 14 illustrating the brace in an operative position on the card.

FIG. 16 is a plan view of another die embodiment to enable the forming of the brace shown in FIGS. 13-15.

FIG. 17 is a plan view of a platen to operate with the die illustrated in FIG. 16.

FIG. 18 is a plan view of another embodiment of a platen.

### DETAILED DESCRIPTION OF PREFERRED EMBODIMENTS OF THE INVENTION

While the present invention is open to various modifications and alternative constructions, the preferred embodiments illustrating the best mode contemplated by the inventors of carrying out their invention are shown in the various figures of the drawing and will be described herein in detail, pursuant to Title 35 U.S.C. section 112 (first paragraph). It is understood, however, that there is no intention to limit the invention to the particular embodiments, forms or examples which are disclosed herein. To the contrary, the intention is to cover all modifications, equivalent structures and methods, and alternative constructions falling within the spirit and scope of the invention as defined in the appended Claims section attached hereto, pursuant to Title 35 U.S.C. section 112 (second paragraph).

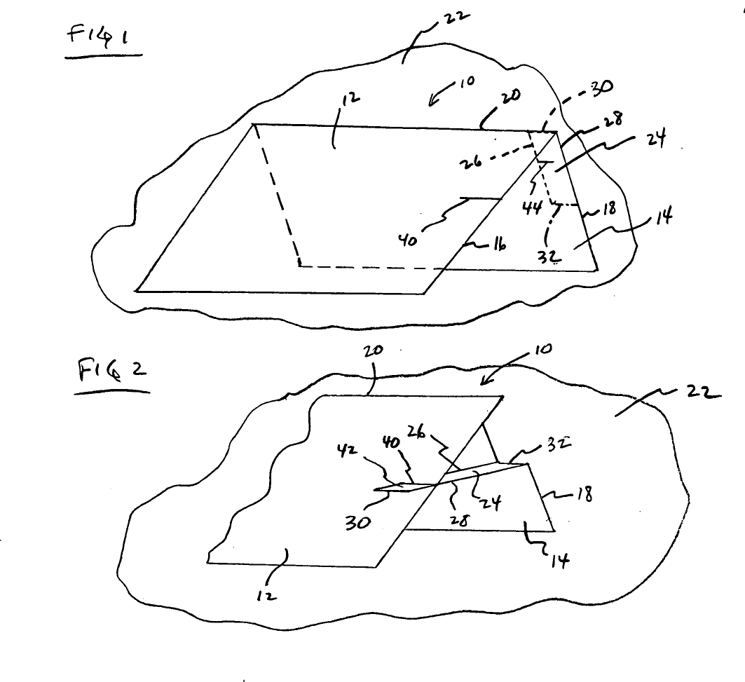

The above mentioned application Ser. No. ______ describes among other things a greeting and place card which may have a brace formed from part of the card. An example of such a card is shown in FIGS. 1 and 2 where a paper card 10 is illustrated. The card 10, which may be a greeting or place card, has a front panel 12 integral with a rear panel 14, the panels having side edges 16 and 18. The panels meet at a fold 20 so as to allow the card to assume a saw horse or A-frame stance when it is desired to display the card on a surface 22. Formed from the rear panel is a brace 24 having inner and outer long sides 26, 28 and upper and lower short sides 30, 32 so as to have a rectangular configuration. The outer long side 28 is coincident with a portion of the side edge 18 of the rear panel 14. The upper short side 30 is coincident with a portion of the fold 20 of the card.

The inner long side 26 of the brace is formed by perforations or a cut as is the upper short side 30. The lower short side 32 of the brace may be formed by a score bar to facilitate folding of the brace downwardly as it is shown in FIG. 2. The front panel 12 of the card may include a slit or cut 40 for receiving one end portion 42 of the brace.

When a card recipient, for example, desires to display a season's greeting card, the perforated or cut long side 26 of the brace 24 and the upper short side 30 are separated from the rear panel 14 of the paper card and the brace 24 is bent forward along the scored lower short side 32. The extended end portion 42 is inserted into the slit 40 in the front panel 12 of the card 10 so as to form a framework thereby increasing the stability of the displayed card in the position shown in FIG. 2. It is noted that the extended end portion 42 of the brace 24 may also include a slit 44 that receives the front panel slit 40 or the slit 44 of the brace may receive the panel edge 16.

It is noted that the perforations, cuts and/or the score line may be formed when the card is manufactured. Or, a card recipient or user may be in possession of an apparatus to form the perforations, cuts and/or score line in any paper card after the card is purchased or received. It is noted with emphasis, the inner long side and the upper short side of the brace may be perforated or cut. Also, the lower short side is preferably scored so as to facilitate folding, however, it need not be scored and a fold may be created by simple manipulation of the brace after it is partially separated from the card.

It is to be further noted that the upper short side 30 may be spaced from the fold 20 of the card so that when the brace is separated from the card, there is more of a “cutout” or “notched” appearance than exists when the upper short side 30 of the brace and a portion of the center fold 20 of the card are coincident.

One embodiment of the present invention is a hand held, hand operated apparatus 50, FIGS. 3-5, which may be used to selectively perforate and/or cut a paper card to form a brace, all in one operation. The apparatus may include a first channel shaped arm 52 having a first end portion 54 and a second end portion 56. The second end portion 56 may be connected to a pin 58. The apparatus may also include a second channel shaped arm 60 having a first end portion 62 and a second end portion 64. The second end portion 64 of the second arm 60 may also be connected to the pin 58 so that the arms 52, 60 may pivot relative to one another. The pin may take the form of a shaft or rivet and form a hinge. A biasing element, such as a spring 66, may be located around the pin or adjacent to the pin so as to cause the first end portions 54, 62 of the first and second arms to be spaced apart as shown in FIGS. 3 and 5.

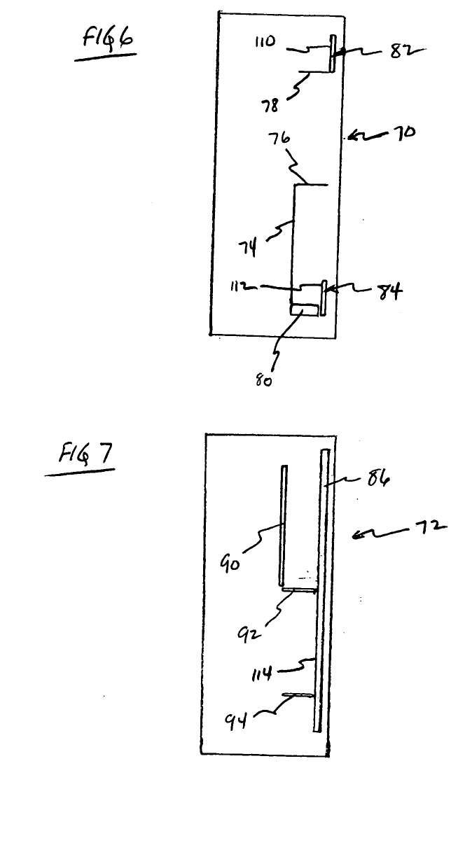

Attached to the first end portion 54 of the first arm 52 is a die 70 and attached to the first portion 62 of the second arm 60 is a platen 72. The die may include a long cutting blade 74, FIG. 6, a first short cutting blade 76 adjacent to the long blade 74 and generally disposed perpendicular to the long blade, a second short cutting blade 78 spaced from both the long blade 74 and the first short blade 76, and a scoring bar 80 also positioned adjacent to the long blade 74 but spaced from both the first and the second short blades 76, 78. The die may also include spacer bars 82, 84. The spacer bars or a single spacer bar 86, FIG. 7, and the scoring bar may alternatively be mounted on the platen 72, if desired. The die may be made of metal into which the blades are fixed in any suitable manner. The platen may also be made of metal with openings 90, 92, 94 to receive and accommodate the cutting blades or the platen may be formed of other suitable material, such as cork. Another opening or openings, not shown, may be formed in the platen to receive and accommodate the spacer bars 82, 84.

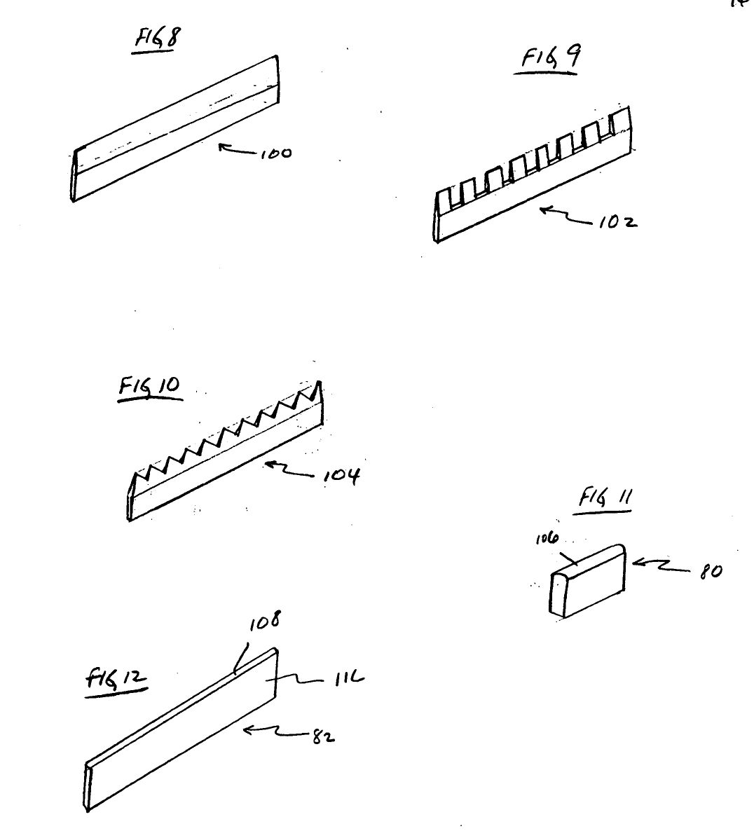

The long blade 74 and the first short blade 76 may include a continuous sharp edge 100 as shown in FIG. 8 or an interrupted edge having a gear tooth shape 102, FIG. 9, or the blades may have a saw tooth shape 104, FIG. 10. The gear tooth and saw tooth blades 102, 104 will, when pressed against a paper card, cause a perforated cut while the uninterrupted or continuous sharp edge cutting blade 100 will cause a cut or slit of the paper.

The scoring bar 80 may have a blunt or rounded edge 106, FIG. 11, so as to score, compress or indent the paper card and thereby facilitate bending the paper at the location of the score line. The two spacer bars 82, 84 may have a flat edge 108, FIG. 12, because they act to abut and locate the apparatus relative to the side edges of the paper card. The card abuts the upstanding side surface or surfaces 110, 112, FIG. 6, 114, FIG. 7, 116, FIG. 12, of the spacer bars. The lengths of the long blades and the short blades and their spacing may be of any suitable dimension, however, it has been found that the long blade may be about 1⅛ inches and that the short blades may be about 5/16 inches each. The distance between the two short blades may be about an inch. It is to be understood that dimensions may change if, for example, the brace is made in locations different from that shown in FIGS. 1 and 2, or if the card is larger or smaller than those depicted.

For example, on cards illustrated in FIGS. 17 and 24 in the above mentioned application Ser. No. ______, the brace may be larger because the cards may be larger. It is noted that the dimensions of the brace, and thereby the blades and even the full apparatus, are a function of the size of the paper card to be cut. It is also noted that the blades may be spaced differently or may even be adjustable, if desired.

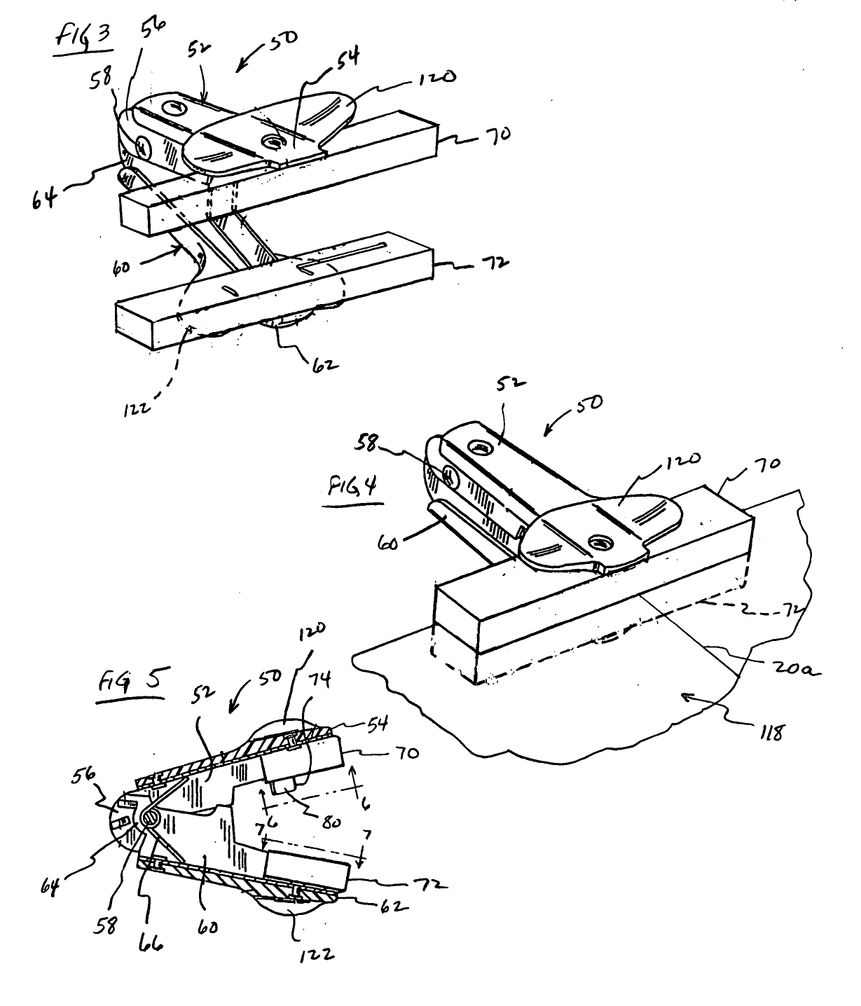

In relation to the paper card illustrated in FIGS. 1 and 2, the long cutting blade 74 will, when the apparatus 50 is used to form the brace 24 in the rear panel 14, form the inner long side 26 of the brace, the first short blade 76 will form the upper short side 30 of the brace, the scoring bar 80 will form the lower short side 32 of the brace and the spaced apart second short blade 78 will form the slit 40 in the front panel 12 of the card. This relationship is depicted in FIG. 4 where a paper card 118 is shown inserted between the die 70 and the platen 72, the card having a central fold 20a.

It is noted that the die 70 and platen 72 may be used in automatic punch equipment so as to form the brace in the same operation that forms the card and causes it to be printed. Or, the arrangement of cutting blades and scoring bar may be formed on a larger die which is also used to cut a card from a larger stock of paper.

In use of the apparatus 50, FIGS. 3-7, the side edges 16, 18 of the card are abutted by the spacer bars 82, 84 while the first short blade 76 may be aligned with the fold 20 (or 20a). The two arms 52, 60 are then brought together by the fingers of an operator, as shown in FIG. 4, to cut, slit or perforate and score the card. This process is simple, easy and quickly accomplished. To facilitate handling the apparatus, each of the arms may have molded plastic wing structures 120, 122 to be manipulated by the fingers of an operator. The wing structures allow the apparatus to operate like a common staple remover of the type illustrated in U.S. Pat. No. 3,598,367, for example.

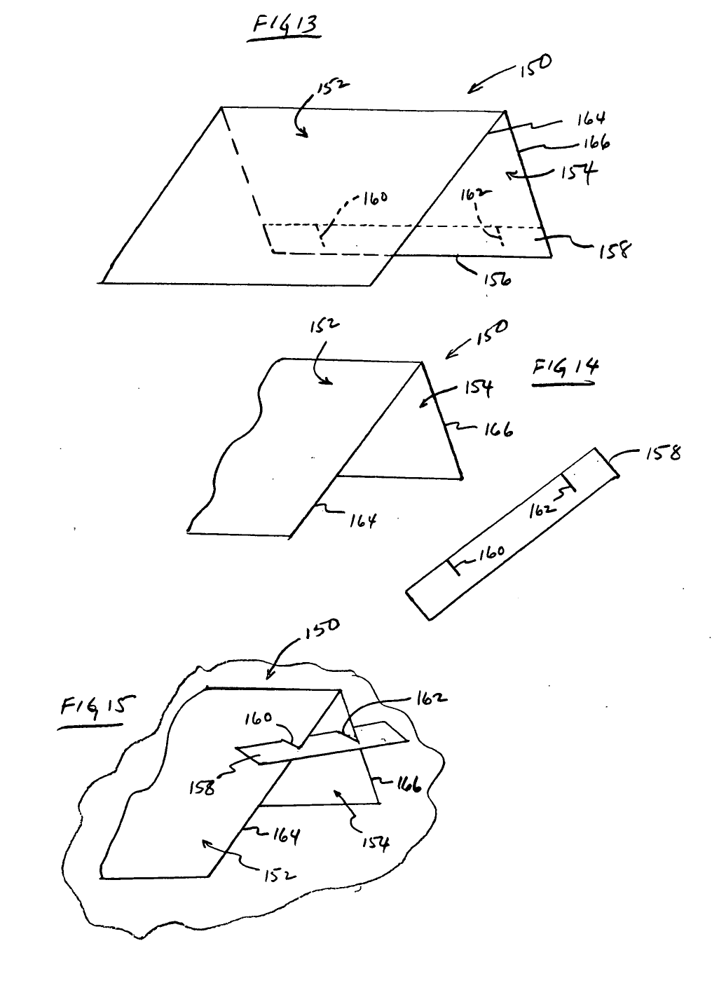

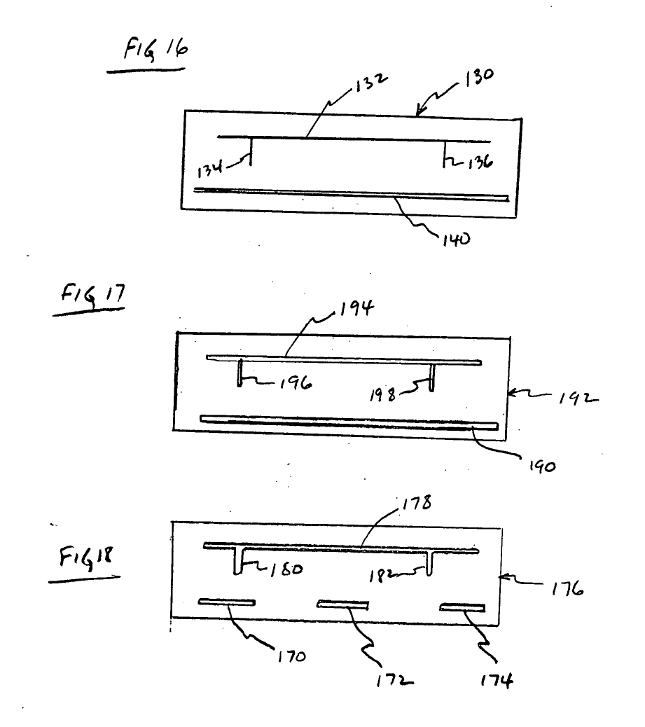

Second and third embodiments of the invention are illustrated in FIGS. 16-18 and may be used with a paper card of the type illustrated in FIGS. 13-15. The perforation or cutting apparatus is similar to that shown in FIGS. 3-5 except that the die 130, FIG. 16, includes a long blade 132 and may also include two short blades 134, 136, positioned perpendicular to the long blade as shown. An elongated spacer bar 140 may also be used. The paper card 150, FIGS. 13-15, has a front panel 152, a rear panel 154 and a bottom edge 156 along the rear panel. To form a brace 158, the apparatus is placed such that the bottom edge 156 abuts the spacer bar 140. The spacer bar may be located about one-half to one inch from the long blade 132 so as to create a brace one-half to one inch wide. The short blades 134 and 136 form slits 160, 162 in the brace so that after the brace is perforated or slit, it may be removed from the card and attached to the card such that the side edges 164 and 166 of the card panels 152, 154 are received by the brace slits 160, 162 to help stabilize the card in an A-frame stance as shown in FIG. 15.

It is noted that the slits may be cut into the card panels as well, and there may be an absence of slits on the brace. In such circumstances, the card slits receive the brace. A third variation is to form slits in both the card panels and in the brace and pairs of slits align and receive each other to form a connection between the brace and the card panels as discussed with the card embodiment 10, FIGS. 1 and 2.

It is further noted that spacer bars 170, 172, 174, FIG. 18, may be placed on the platen 176 near the openings 178, 180, 182 that receive and accommodate the blades. In a variation spacer bars may not be used, or in another variation, a single spacer bar 190, FIG. 17, is placed on the platen 192 near the openings 194, 196, 198 that receive and accommodate the blades of the die 130.

The above specification describes several preferred embodiments of the present invention. Other examples, embodiments, modifications and variations will, under both the literal claim language and the doctrine of equivalents, come within the scope of the invention defined by the appended claims. For example, the size and arrangement of blades may be a function of the size of the card or the desired location of the brace on the card. Also, the blades may cut or perforate or perform a combination of these functions, if desired. The variations all result in equivalent structures and all will also come within the literal language of the claims. Still other alternatives and modifications will also be equivalent as will many new technologies. There is no desire or intention here to limit in any way the application of the doctrine of equivalents nor to limit or restrict the scope of the invention as express by the following claims.

1. A hand held, hand operated paper card brace forming apparatus comprising:
a first arm;
a die connected to the first arm;
a second arm pivotally connected to the first arm;
a platen for mating with the die, the platen being connected to the second arm; and
a biasing element connected to the first and the second arms for spacing the arms from one another.

2. The apparatus as claimed in claim 1 wherein:
the die includes an elongated blade.

3. The apparatus as claimed in claim 2 wherein:
the die includes a shorter blade attached at generally a right angle to the elongated blade.

4. The apparatus as claimed in claim 3 wherein:
the die includes a second shorter blade spaced from the first mentioned shorter blade.

5. The apparatus as claimed in claim 4 wherein:
the die includes a scoring bar attached adjacent to the elongated blade and at generally a right angle to the elongated blade.

6. The apparatus as claimed in claim 5 including:
a spacer bar connected to the die.

7. The apparatus as claimed in claim 1 wherein:
the die includes two spaced apart blades extending perpendicular to the elongated blade.

8. A hand operated paper card cutting apparatus comprising:
a first elongated arm having first and second end portions;
a second elongated arm having first and second end portions;
a pin connected to the second end portions of the first and the second arms to enable the first and the second arms to pivot relative to each other;
a spring connected to the first and the second arms adjacent the pin for biasing the first end portions of the first and the second arms apart;
a die connected to the first end portion of the first elongated arm; and
a platen connected to the first end portion of the second elongated arm.

9. The apparatus as claimed in claim 8 wherein:
the die includes an elongated cutting blade.

10. The apparatus as claimed in claim 9 wherein:
the die includes a shorter cutting blade disposed at a right angle to the elongated cutting blade.

11. The apparatus as claimed in claim 10 wherein:
the die includes another shorter cutting blade spaced from the elongated cutting blade and spaced from the first mentioned shorter cutting blade.

12. The apparatus as claimed in claim 11 wherein:
the cutting blades are structured and dimensioned to perforate paper.

13. The apparatus as claimed in claim 12 wherein:
a scoring bar is formed on either the die or the platen.

14. The apparatus as claimed in claim 13 wherein:
a spacer bar is formed on either the die or the platen.

15. An apparatus for forming a brace on a paper card comprising:
a die having an elongated cutting blade and first and second shorter cutting blades disposed at generally right angles to the elongated cutting blade and the first and the second shorter blades being generally parallel to each other.

16. The apparatus as claimed in claim 15 wherein:
the first shorter blade is disposed adjacent to the elongated blade and the second shorted blade is spaced away from the first shorter blade and the elongated blade.

17. The apparatus as claimed in claim 16 including:
a platen; and wherein
either the die or the platen includes a scoring bar.

18. The apparatus as claimed in claim 17 wherein:
either the die or the platen includes a spacer bar.

19. The apparatus as claimed in claim 18 wherein:
either the die or the platen includes two spaced apart spacer bars.

20. The apparatus as claimed in claim 17 wherein:
the scoring bar forms a fold-line on a paper card adjacent a cut made on the card by the elongated blade and spaced from cuts made on the card by the first and the second shorter blades.
